(19) United States
(12) Patent Application Publication
(10) Pub. No.: US 2015/0272710 A1
(43) Pub. Date: Oct. 1, 2015

(54) THREE-DIMENSIONAL BODY

(71) Applicants: Michael Krischollek, Berlin (DE); Tridenta Dentaltechnik GmbH, Berlin (DE)

(72) Inventors: Michael Krischollek, Berlin (DE); Viola Ilmer, Berlin (DE); Frank Jasper, Berlin (DE)

(21) Appl. No.: 14/669,122

(22) Filed: Mar. 26, 2015

(30) Foreign Application Priority Data
Mar. 26, 2014 (EP) 14161631.8

(51) Int. Cl. A61C 13/00; G06F 19/00; A61C 7/00

(52) U.S. Cl. CPC A61C 13/0004; A61C 7/002; G06F 19/3437

(57) ABSTRACT

A method is described comprising the steps of providing a first and a second medical technology representation of a jaw, recording an anatomically stable right-hand direction point A, A′ (1, 4), an anatomically stable left-hand direction point B, B′ (2, 5), and an anatomically stable induction point C, C′ (3, 6) in a palatinal position in the front tooth area or in a labial position of the upper and lower jaw in the first and second representation, and forming a geometric body with a first area (7) between the points A (1), B (2) and C′ (6) and a second area (8) between the points A′ (4), B′ (5) and C (3) in the first and second representation, and the setting in relation to each other of the first and second representation, whereby the first geometric body and the second geometric body act as a joint reference.

### CROSS-REFERENCE TO RELATED APPLICATIONS

This application claims priority to and the benefit of European Application No. 14161631.8, filed Mar. 26, 2014, which is hereby incorporated herein by reference in its entirety.

### FIELD OF THE INVENTION

The invention relates to a method for placing two or more representations of a jaw with upper and lower jaw in relation to each other.

### BACKGROUND OF THE INVENTION

In the field of orthodontics, prosthetic dentistry and tooth implantation, computer-supported therapy plans are increasingly being used. These are applied in order to calculate the size, dimensions and integration of dentures such as inlays, bridges or crowns. In particular, Computer-Aided Design, or CAD, is used to produce implants for individual or several teeth through to a complete set of teeth. The design and positioning of the implant are usually based on photographs of the jaw or three-dimensional scans of plaster models, which are produced on the basis of jaw impressions. The implants or bridges are designed on the computer and produced using computer-aided milling techniques. Different dental diagnostic photographic techniques are used depending on the type of medical application, such as panorama x-rays, photographs of dental films of individual teeth or rows of teeth, intraoral scan, computer tomography and three-dimensional volume tomography. Due to the different photographic techniques, standards, photograph angles and different partial areas of the jaw or set of teeth shown, however, it is almost impossible to reliably compare them with representations photographed at an earlier date. This would be desirable, however, in order to be able to determine changes to the jaw and to the status of the teeth. Over time, both the jaw and the status of the teeth change, in some cases even to the extent that individual or several teeth are lost. When treating tooth defects, the key aim is currently to maintain the current state or complete the set of teeth using tooth-preserving measures or tooth replacement. Here, changes to the jaw beyond the defect that is to be treated directly are usually ignored, since in retrospect, it is almost impossible to deduce how the current state differs from the original state of the jaw. However, with the jaw, the occlusion and articulation of the upper and lower jaw also change at regular intervals, as a result of which cranio-mandibular dysfunctions arise. With orthodontic measures which are only able to focus on the current state, such changes cannot be compensated, so that despite the treatment, the patient may continue to suffer from impairments.

Thus there is a need for a method to compare and evaluate different dental diagnostic photographs, so that an original, optimal tooth status can be reinstated.

### SUMMARY OF THE INVENTION

The present invention relates to a method comprising the steps of:

a) Providing a first medical technology representation of a jaw, with upper jaw and lower jaw,
a₁ Recording an anatomically stable right-hand direction point A, an anatomically stable left-hand direction point B, and an anatomically stable induction point C in a palatinal position in the front tooth region of the upper jaw in the first representation,
a₂ Recording an anatomically stable right-hand direction point A′, an anatomically stable left-hand direction point B′, and an anatomically stable induction point C′ in a labial position of the lower jaw in the first representation,
a₃ Forming a first geometric body with a first area between the points A, B and C′ and a second area between the points A′, B′ and C in the first representation,

b) Providing a second medical technology representation of the jaw,
b₁ Recording an anatomically stable right-hand direction point A, an anatomically stable left-hand direction point B, and an anatomically stable induction point C in a palatinal position in the front tooth region of the upper jaw in the second representation,
b₂ Recording an anatomically stable right-hand direction point A′, an anatomically stable left-hand direction point B′, and an anatomically stable induction point C′ in a labial position of the lower jaw in the second representation,
b₃ Forming a second geometric body with a first area between the points A, B and C′ and a second area between the points A′, B′ and C in the second representation, and

c) Setting in relation to each other the first and second representation, whereby the first geometric body and the second geometric body act as a joint reference.

The invention further relates to a computer program comprising a program code designed to control a computer to implement the steps of the method according to the invention when the computer program is implemented on a computer.

Furthermore, the invention relates to a medical technology representation device for displaying at least two medical technology representations of a jaw, comprising a data storage device which stores a first and a second medical technology representation of the jaw, a data processing device which forms a first geometric body in the first representation and a second geometric body in the second representation, and a graphic processing device which displays the first and second representation, wherein the first and second are arranged to correspond to each other in position, whereby the first geometric body and the second geometric body act as a joint reference, characterized in that the first and second geometric body are each formed with a first area between an anatomically stable right-hand direction point A, an anatomically stable left-hand direction point B, and an anatomically stable induction point C in a palatinal position in the front tooth area of the upper jaw, and a second area between an anatomically stable right-hand direction point A′, an anatomically stable left-hand direction point B′, and an anatomically stable induction point C′ in a labial position of the lower jaw.

### BRIEF DESCRIPTION OF THE FIGURES

FIGS. 1A, 1B, 1C and 1D show representations of a geometric body which is formed by two areas. The first area (7) is tensioned by the points A (1), B (2) and C′ (6) and the second area (8) is tensioned by the points A′ (4), B′ (5) and C (3). With the geometric body represented in FIG. 1A, the first area (7) and the second area (8) intersect on the outer edges [AC′] (9) and [A′C] (11) and in the outer edges [BC′] (12). With the geometric body represented in FIG. 1B, the first area (7) passes through the second area (8) so that the longitudinal edges of the first area (7) [AC′] (9) and [BC′] (10) intersect in the entry points D₁ (13) and D₂ (14). With the geometric body represented in FIG. 1C, the second area (8) passes through the first area (7), so that the longitudinal edges of the second area (8) [A′C] (11) and [B′C] (12) intersect the first area (7) in the entry points D₁ (13) and D₂ (14). With the geometric body shown in FIG. 1D, the first and second areas intersect in such a manner that the longitudinal edge of the first area (7) [BC′] (10) intersects the second area (8) in the entry point D₂ (14) and the longitudinal edge of the second area (8) [A′C] (11) intersects the first area (7) in the entry point D₁ (13).

FIG. 2 show the geometric body represented in FIG. 1A with a first vertical sectional plane Sᵥ⁰ (15) and a further sectional plane Sᵥ¹ (16) which is arranged in parallel.

FIG. 3 shows the geometric body represented in FIG. 1A with a first horizontal sectional plane S_{H}⁰ (17) and a further horizontal sectional plane S_{H}¹ (18) which is arranged in parallel to S_{H}⁰.

FIGS. 4A and 4B show the cranial reference points according to Staub in the upper jaw (A) and the lower jaw (B). The right-hand direction point A (1) lies in the right-hand upper jaw half at the point of the change of direction of the line which continues from the middle of the jaw ridge to the hamulus pterygoideus, from convex to concave. The left-hand direction point B (2) lies on the corresponding point in the left-hand upper jaw half. Induction point C (3) is the intersection between the median axis of the upper jaw and the posterior contour of the papilla (19). The right-hand direction point A′ (4) lies in the right-hand lower jaw half on the point of the change of direction from convex to concave of the mesio-distal progression curve of the ridge connection line on the distal end of the trigona retromolare. The left-hand direction point B′ (5) lies on the corresponding point in the left-hand lower jaw half. The induction point C′ (6) of the lower jaw is the intersection of the median axis of the lower jaw with the conclusion line, which forms the boundary line between the movable and immovable mucous membrane in front of the incisors.

FIGS. 5A, 5B and 5C show photographs of a jaw with teeth in which a geometric body is arranged. The jaw is represented from the front (A), from the rear (B) and from a side perspective (C).

FIGS. 6A, 6B and 6C show a splint for any row of teeth for the upper jaw (A) and for the lower jaw (B). On the upper jaw splint (20), the direction points A (1), B (2) and induction point C (3) are marked in the form of drill holes. FIGS. 6A, 6B, and 6C show the representation of an intraoral scan of an upper jaw, which was conducted when the upper jaw splint (20) was inserted. Induction point C (3) is marked by a drill hole in the upper jaw splint (20).

### DETAILED DESCRIPTION OF THE INVENTION

In a first aspect the invention relates to a method comprising the steps of:

a) Providing a first medical technology representation of a jaw, with upper jaw and lower jaw,
a₁ Recording an anatomically stable right-hand direction point A, an anatomically stable left-hand direction point B, and an anatomically stable induction point C in a palatinal position in the front tooth region of the upper jaw in the first representation,
a₂ Recording an anatomically stable right-hand direction point A′, an anatomically stable left-hand direction point B′, and an anatomically stable induction point C′ in a labial position of the lower jaw in the first representation,
a₃ Forming a first geometric body with a first area between the points A, B and C′ and a second area between the points A′, B′ and C in the first representation,

b) Providing a second medical technology representation of the jaw,
b₁ Recording an anatomically stable right-hand direction point A, an anatomically stable left-hand direction point B, and an anatomically stable induction point C in a palatinal position in the front tooth region of the upper jaw in the second representation,
b₂ Recording an anatomically stable right-hand direction point A′, an anatomically stable left-hand direction point B′, and an anatomically stable induction point C′ in a labial position of the lower jaw in the second representation,
b₃ Forming a second geometric body with a first area between the points A, B and C′ and a second area between the points A′, B′ and C in the second representation, and

c) Setting in relation to each other the first and second representation, whereby the first geometric body and the second geometric body act as a joint reference.

The method according to the invention enables a comparison between two or more different representations of a jaw, regardless of whether the photographs were taken under the same conditions or using the same method. As a result, the difference between two different states, which are reproduced by the first and second representation, can be ascertained. On the basis of this difference, the design of a dental product can be determined and the product can be created. If one of the representations shows a medically advantageous original jaw state, from which the current state deviates, a dental product can be produced in order to reconstruct this original state. This makes it possible to reinstate the original articulation and occlusion of the jaw, and to avoid cranio-mandibular dysfunctions.

The term “representation” as used here comprises every type of display of a jaw, wherein for the method according to the invention, it is preferred that three-dimensional representations are used. The possible representations include both visual displays such as medical technology photographs, preferably digital three-dimensional photographs and reconstructions, as well as three-dimensional models of a jaw or parts thereof, such as plaster models or dental arches of the upper and lower jaw. The term “jaw” as used here comprises the upper and lower jaw, wherein both the jaw bones and the set of teeth or teeth insofar as they are present, and to what extent, are included.

The method is based on the insight that using six anatomically stable reference points in the upper and lower jaw (direction points A, A′, B, B′ and induction points C and C′) allows one to form a geometric body. This body results from a first area, which is form by points A, B and C′, and from a second area, which is formed by points A′, B′ and C. Due to the fact that the reference points can be identified in every representation of the jaw and that from them, a geometric body is formed for every representation, the different representations can be set in relation to each other. The geometric body is determined by the six stable reference points and is unique for each patient. Consequently, the geometric body is also the same for every representation of the jaw of a patient, so that it can be used as a reliable reference. For example, two digital displays of the same jaw can be aligned on the basis of the geometric body formed in every representation, so that the different representations of the jaw can be arranged in accordance with each other. This can be done in separate representations or in a combined image of both representations, for example as a superimposed image. Equally, it is possible to arrange two plaster models of a jaw to correspond to each other in position on the basis of the geometric body, for example by using an alignment device into which both models are clamped. With the aid of a transfer device with calliper tips such as the one described in EP 12 188 176.7, the difference can be measured between the two representations.

In order to implement the method, the reference points are first determined in all representations of the jaw of the patient and the geometric body is formed. Here, at least one of the representations should if possible show a complete upper and lower jaw, wherein the jaw can be with a full or partial set of teeth, or entirely without teeth. In the upper and lower jaw, two direction points in each case (a right-hand direction point A, A′ and a left-hand direction point B, B′) and an induction point C, C′ which lies in a palatinal position in the front tooth area (upper jaw) or in a labial position (lower jaw) are recorded. As direction points and induction points, anatomically stable points within the jaw are selected, wherein the direction points A/A′ and B/B′ lie on points on the right and left-hand upper and lower jaw half which correspond to each other. The right-hand direction points of the upper and lower jaw (A, A′) lie in the right-hand jaw half and the left-hand direction points (B, B′) lie in the opposite position on the left-hand jaw half. The induction point is by contrast localised in the front tooth area, whereby in the upper jaw it lies in a palatinal position, i.e. behind the front teeth, preferably behind the incisors, and in the lower jaw it lies in a labial position, i.e. in front of the front teeth, preferably in front of the incisors. The term “anatomically stable” here describes points the position of which in the jaw during the time that has passed between the photographs of the different representations has remained unchanged. Preferably, these are points the position of which remains the same throughout life, or at least after completion of development.

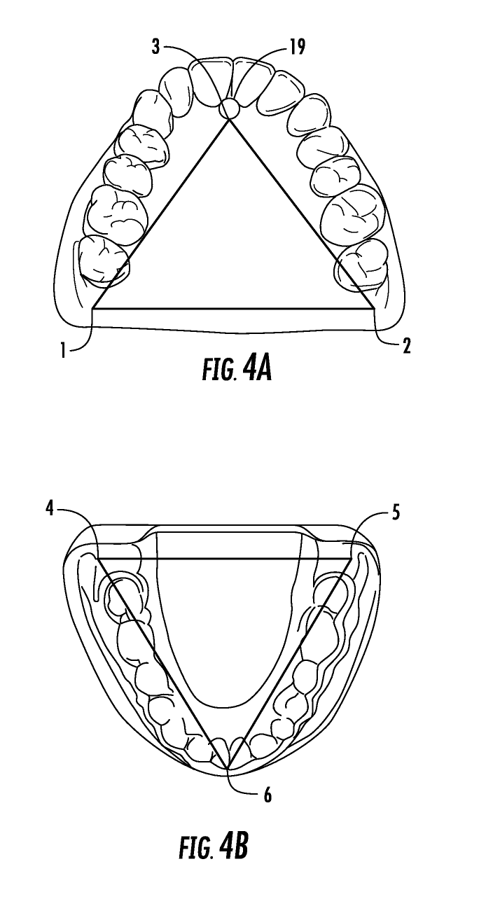

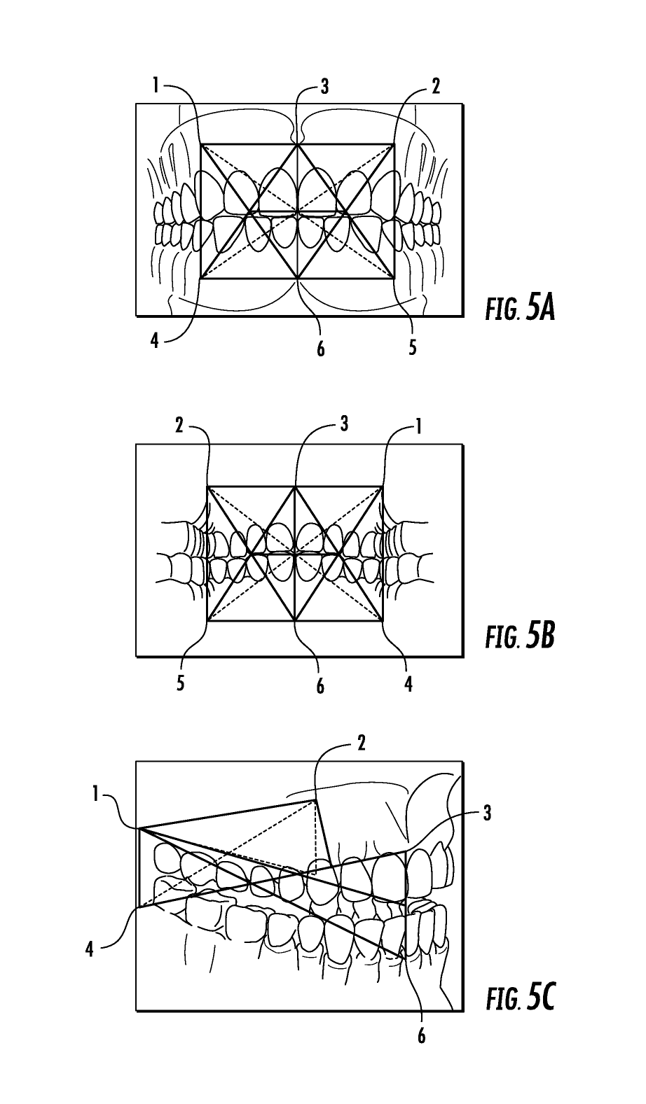

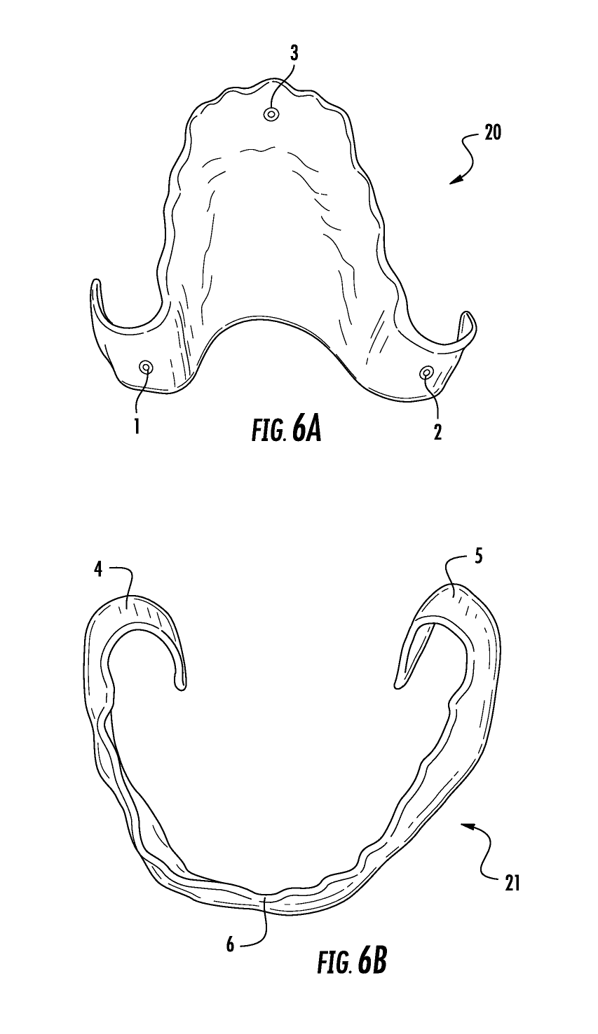

In a preferred embodiment, the anatomically stable direction points (A, A′, B, B′) and the anatomically stable induction points (C, C′) are determined using the Staub cranial method. The cranial reference points identified and described by Karl-Heinz Staub can be identified in any jaw, and remain unchanged after termination of the development stage (Teubner & Marinello 2006; Lampropoulos 2003). According to the Staub method, the right-hand direction point A is the point in the right-hand half of the upper jaw where the line which extends from the centre of the jaw ridge to the hamulus pterygoideus changes its direction from convex to concave, and the left-hand direction point B is the point in the left-hand half of the upper jaw where the line which extends from the centre of the jaw ridge to the hamulus pterygoideus changes its direction from convex to concave. Induction point C is the point of the upper jaw where the median axis of the upper jaw intersects the posterior contour of the papilla (FIG. 4A). Furthermore, the right-hand direction point A′ is defined as the point in the right-hand half of the lower jaw where the mesio-distal progression curve of the ridge connection line at the distal end of the trigona retromolare changes its direction from convex to concave. The left-hand direction point B′ is accordingly the point in the left-hand half of the lower jaw where the mesio-distal progression curve of the ridge connection line at the distal end of the trigona retromolare changes its direction from convex to concave. Induction point C′ of the lower jaw is the point at which the median axis of the lower jaw intersects the conclusion line. The conclusion line is the boundary line between the movable and immovable mucous membrane in front of the incisors (FIG. 4B). The use of the cranial reference points according to Staub is particularly preferred when the different representations were photographed with a clear time interval, such as one of at least two years, since these points remain unchanged throughout life.

For a comparison of photographs that have been taken after brief time intervals, however, other points in the right and left-hand half, as well as in the front tooth region of the upper and lower jaw, can be selected. A precondition for this is only that the points can be clearly determined in all representations.

The six reference points can be recorded in different ways. For example, they can be determined and marked on the basis of their anatomical position in every representation.

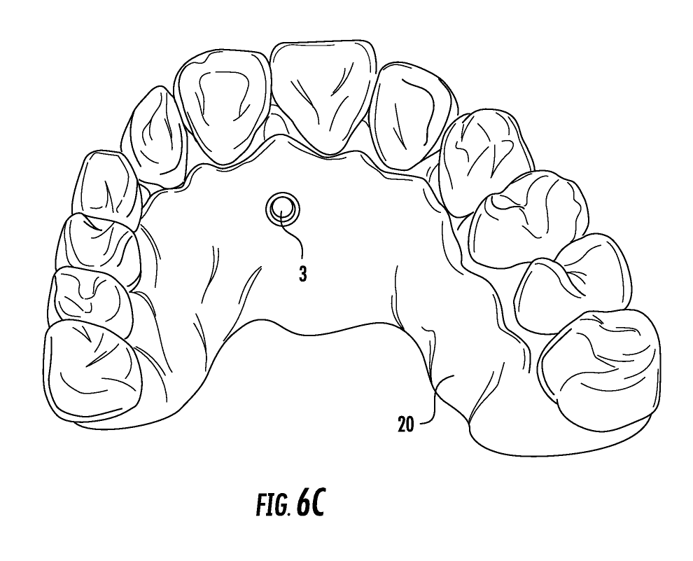

In a preferred embodiment, the reference points were marked when the first and/or second representation was/were created, whereby the representation was created using a splint for any row of teeth for the upper jaw and a splint for any row of teeth for the lower jaw. Furthermore, the position of the reference points, such as on the basis of a plaster model of the jaw of the patient, is determined. Then, two splints for any row of teeth, one for the upper jaw and one for the lower jaw, are created, on which the reference points are marked (FIG. 6A, B). For photographs with visible light, such as intraoral scans, colour markings or holes of a defined size, the centre of which represents the size of the individual reference points, are attached to the splint (FIG. 6C). For X-ray or tomographic photographs, the position of the reference points can be marked using opaque materials on the splint. In the representation of the jaw, these markings later appear as white dots. The splints are inserted into the jaw of the patient while photographing the first and/or second representation. In this way, with the aid of the markings on the splints, the reference points are directly shown in the representations of the jaw.

The position of the reference points can also be determined using a plaster model, either manually or using graphics of curve measurements with unlimited possibilities (Staub 2002).

In a preferred embodiment, the first and/or second representation comprises a complete upper and lower jaw. When the representation shows a complete jaw, all six reference points can be clearly identified. If one of the representations shows only a part or several parts of the upper and/or lower jaw, so that not all reference points are immediately visible, the missing reference points can be calculated. The geometric body is for this purpose determined on the basis of a representation, e.g. a three-dimensional plaster model of the jaw in which all six reference points can be seen. Then, starting from at least three reference points, the position of the remaining points can be calculated. Preferably, in each case at least one of the reference points is located in the upper and lower jaw.

As soon as the reference points have been determined, the geometric body is formed by means of two areas. The first area is generated between the direction points of the upper jaw (A, B) and the induction point of the lower jaw (C′). The second area is generated between the direction points of the lower jaw (A′, B′) and the induction point of the upper jaw (C). Here the two planes intersect at a point which is individual and constant for each patient. The reference points are recorded in every representation and for every representation, a geometric body is formed. Since the reference points and thus also the geometric body are specific to each patient, the geometric bodies of the different representations correspond to each other in position. Thus the different representations can be set in relation to each other, wherein the geometric body acts as a reference. This is possible, for example, by assigning each point in the representation a coordinate in relation to the geometric body. When the coordinates are assigned identically in each representation, the same coordinates of different representations designate identical points in the jaw of the patient. This makes it possible to precisely determine which point in the first representation corresponds to which point in the second one.

In a preferred embodiment, the first and second representation are set in relation to each other by arranging the first and second geometric body to correspond to each other in position. If the representations are aligned in such a way that the geometric bodies correspond to each other, the jaws shown are thus identically positioned. This enables a direct comparison of the representations, on the basis of which deviations between the different states can be calculated. If the representations are digital three-dimensional photographs, these can be rotated virtually on the screen in such a way that the geometric bodies are aligned with each other. The differences between the photographs can thus be precisely recorded. They can be calculated using the corresponding software, and the data gained can be used to produce a dental product. If plaster models of a jaw are used as representations, they can be clamped in an alignment device and positioned identically on the basis of the geometric bodies. This option can be used in particular for the manual production and adaptation of dental products.

In a preferred embodiment, the first and second representation are merged in a joint image, whereby the first and second geometric body are arranged congruently. For this purpose, several three-dimensional digital images of a jaw are merged in a single image, i.e. are laid one on top of the other so that both representations remain visible, as a result of which a new image of the jaw is created. When the geometric bodies are arranged congruently in the representations, the jaws are also positioned congruently. This embodiment is particularly suited for combining different representations of a jaw which have been created using different photographic techniques. As a result, the different pieces of information which have been gained through different photographic techniques can be combined in a single representation. For example, a digital volume tomographic photograph can be superimposed with an intraoral scan in a single image. When producing a dental product, both the anatomical state of the jaw and the surface conditions of the teeth can be taken into account. Furthermore, it is also possible to superimpose photographs that have been taken at different points in time.

In a preferred embodiment, the method according to the invention further comprises the step of providing at least one further medical technical representation of the jaw and implementing steps b₁ to b₃ for the at least one further representation, wherein in step c the first, second and at least one further representation are set in relation to each other, whereby the first, second and at least one further geometric body act as a joint reference. The method can be implemented with as many representations of the jaw as required. Accordingly, all the embodiments of the method described here can also be implemented with several representations. For example, a plurality of representations which have been photographed over a period of several years can be compared in order to determine changes to the jaw over the period of time.

In a preferred embodiment, the method according to the invention further comprises the formation of at least one sectional plane through the geometric body in the first and second representation, characterized in that the first and second representation are set in relation to each other, whereby at least one part of the at least one sectional plane of the first representation and the corresponding part of the at least one sectional plane of the second representation are arranged to correspond to each other in position. Using the geometric bodies, which are formed in each of the representations, and which are identical in their form, it is possible to lay sectional planes through the representations, the positions of which are clearly defined in relation to the jaw shown. For embodiments of the method in which sectional planes are formed, three-dimensional digital representations of the jaw are preferably used, such as three-dimensional X-ray images, volume tomography photographs and/or intraoral scans. Here, the sectional planes are not determined in the standard manner in relation to the dimensions of the representation, but in relation to the jaw of the patient. This is possible by aligning the sectional planes on the geometric body, which in turn is directly determined by the anatomy of the jaw of the patient. In order to set the two representations of the jaw in relation to each other, the planes are generated at identical positions of the geometric body in the first and second representation. The geometric body which is identical for each representation of the jaw of a patient acts here as a reference, so that sectional planes which exactly correspond to each other can be formed in different representations. The inclusion of individual or several planes in the different representations of the jaw makes it possible to compare individual precisely corresponding parts of the jaw in the different representations. This can be done on the basis of individual representations which are set opposite each other, wherein the jaws are represented in such a way that the sectional planes are arranged to correspond to each other in position. Alternatively, the parts of the representations which are covered by the sectional planes can be merged in a joint image, wherein the sectional planes are arranged congruently. With the aid of the sectional planes, individual areas of the jaw can also be extracted from a representation in order to superimpose them over a second representation at the position which corresponds to them. Equally, individual planes of a representation, such as those planes which comprise the tooth crowns of the lower jaw, can be projected into another representation. For this purpose, the sectional planes from the first representation are projected onto the corresponding position of the sectional planes in the second representation in order to replace them or superimpose them over those already present. If in this way two representations are analysed that were photographed at different points in time in the life of the patient, specific changes at certain positions of the set of teeth or jaw bone can be identified and deviations can be calculated. A tooth replacement or tooth retention measure can then be implemented in such a manner that these changes are compensated and thus an optimal occlusion and articulation can be reinstated.

In a preferred embodiment, the method according to the invention further comprises the steps of:
a₄ Forming a first vertical sectional plane Sᵥ⁰ through the geometric body in the first representation, which is generated by the points A, A′, B and B′, and forming at least one further vertical sectional plane Sᵥⁿ, which is arranged parallel to Sᵥ⁰, and
b₄ Forming a first vertical sectional plane Sᵥ⁰ through the geometric body in the second representation, which is generated by the points A, A′, B and B′, and forming at least one further vertical sectional plane Sᵥⁿ, which is arranged parallel to Sᵥ⁰.

The first and second representation are then set in relation to each other, whereby at least one part of at least one of the vertical sectional planes of the first representation and the corresponding part of the corresponding vertical sectional planes of the second representation are arranged to correspond to each other in position. The reference points A, A′, B and B′ define a specific plane of the geometric body. Like the geometric body itself, this plane is determined by the anatomically stable points in the jaw of the patient and is thus individual and constant for every patient. The plane generated by points A, A′, B and B′ acts as the basis Sᵥ⁰. In parallel to this, further sectional planes (Sᵥ¹, Sᵥ², Sᵥ³, etc.) can be generated. Here, in the first and second representation of the jaw, corresponding planes are formed. Since the geometric body, which is identical for both representations, acts in each case as a reference, the respective planes correspond to each other and include the corresponding regions of the jaw in the different representations. As many planes as required can be inserted into the representations. For the purpose of analysis, individual planes, groups of planes or parts of one or more planes can be extracted and set opposite each other. Thus, for example, individual areas of several planes, which together cover an individual tooth, can be extracted from a representation and imported into a second representation to be superimposed. In the second representation, the imported planes or parts of these are arranged congruently at their corresponding position with the corresponding planes of the second representation. With the aid of superimposition, the differences between the first and second representation of the affected tooth can be directly visualised, and deviations can be calculated. This also makes it possible to detect minor changes to the set of teeth or in the jaw bone of the patient which would not be recognisable using standard static comparison of different representations. The formation of vertical sectional planes on the basis of the plane Sᵥ⁰ is particularly suitable for applications in which the teeth or jaw bones are examined from the anterior, posterior or lateral position.

In a preferred embodiment, the method according to the invention further comprises the steps of:
a₅ Recording a first entry point (D₁) and a second entry point (D₂) of the geometric body in the first representation, wherein D₁ is the right-hand point and D₂ is the left-hand point where the edges AC′ and BC′ of the first area traverse the second area, the edges A′C and B′C of the second area traverse the first area, or the edge AC′ or BC′ of the first area traverses the second area and the edge A′C or B′C of the second area traverses the first area,
a₆ Forming a first horizontal sectional plane S_{H}⁰ in the first representation, which is generated by the points D₁, D₂ and a point E on a line through the induction points C and C′, and forming at least one further sectional plane S_{H}ⁿ, which is arranged parallel to the first sectional plane,
b₅ Recording a first entry point (D₁) and a second entry point (D₂) of the geometric body in the second representation, wherein D₁ is the right-hand point and D₂ is the left-hand point where the edges AC′ and BC′ of the first area traverse the second area, the edges A′C and B′C of the second area traverse the first area, or the edge AC′ or BC′ of the first area traverses the second area and the edge A′C or B′C of the second area traverses the first area, and
b₆ Forming a first horizontal sectional plane S_{H}⁰ in the second representation, which is generated by the points D₁, D₂ and a point E on a line through the induction points C and C′, and forming at least one further sectional plane S_{H}ⁿ, which is arranged parallel to the first sectional plane.

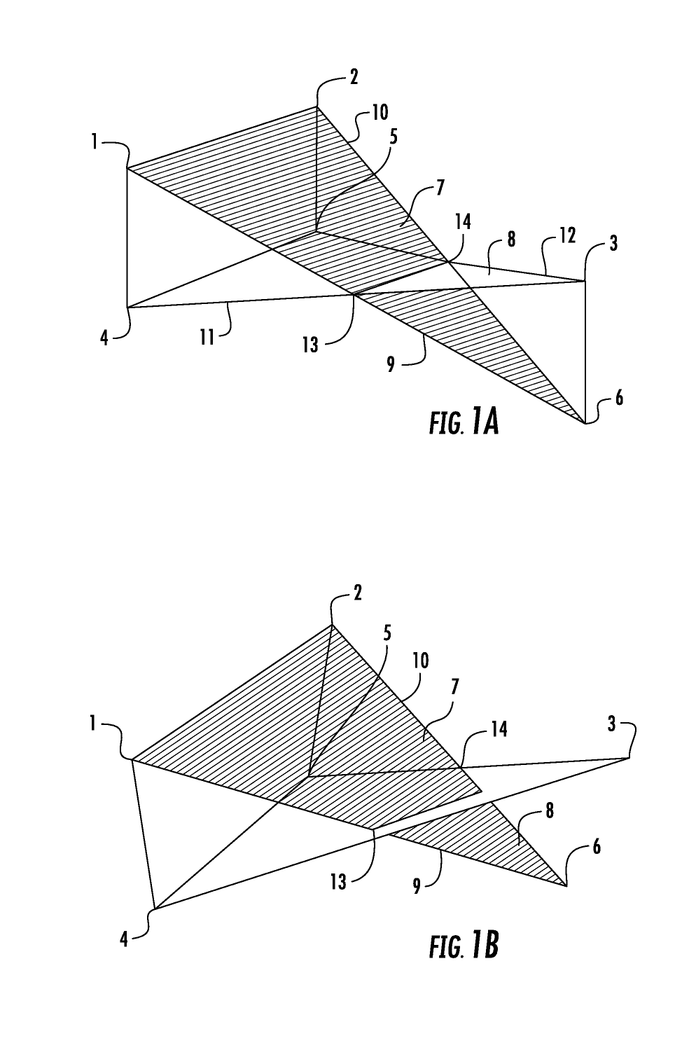

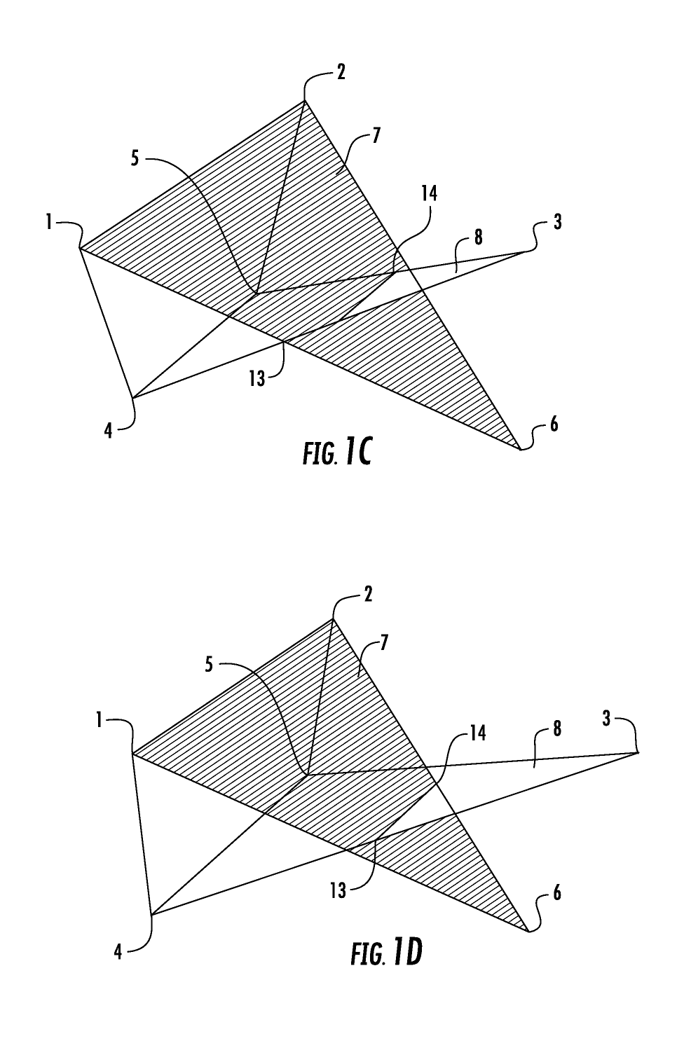

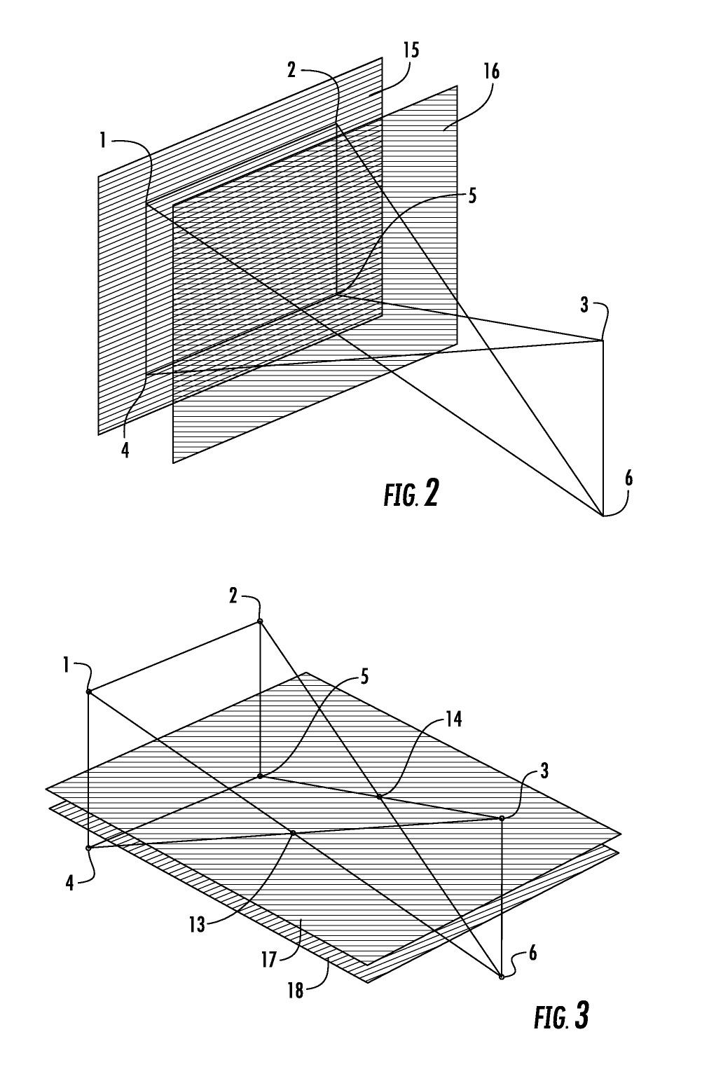

The first and second representation are set in relation to each other, whereby at least one part of at least one of the horizontal sectional planes of the first representation and the corresponding part of the corresponding horizontal sectional planes of the second representation are arranged to correspond to each other in position. The geometric body is formed by two areas which are generated between the points A, B and C′ on the one hand and A′, B′ and C on the other. By including points from the upper and lower jaw respectively when forming both areas, the first and second area of the geometric body cross. The line on which the first and second areas cross is defined by the anatomically stable points in the jaw of the patient. Overall, three different types of crossing-over of the first and second area of the geometric body can be observed. On the one hand, D₁ can be the right-hand point and D₂ the left-hand one where the edges AC′ and BC′ of the first area traverse the second area, or the edges A′C and B′C of the second area traverse the first area. A particular case of this constellation is present when the reference points A, A′, B, B′, C and C′ are largely symmetrically distributed. Then, the first and second area cross over in such a manner that the longitudinal axes [AC′] and [A′C] on the one hand, and [BC′] and [B′C] on the other intersect (FIG. 1A). In this case, the entry points D1 and D2 lie precisely on the intersection points of the longitudinal edges [AC′] and [A′C] and [B′C] and [BC′]. However, since the jaws of most patients are not exactly symmetrical, the first and second area of the geometric body generally cross in such a way that at least one longitudinal axis of an area enters the other area. If for example it is the case that the first area (A, B, C′) is narrower than the second area (A′, B′, C), it enters the second area without touching its longitudinal edges (FIG. 1B). If the second area (A′, B′, C) is narrower than the first area (A, B, C′), it crosses the first area, whereby both longitudinal edges cross the interior of the first area (FIG. 1C). In a third constellation, the edge AC′ or BC′ of the first area traverses the second area, and the edge A′C or B′C of the second area traverses the first area. If the first and second area of the geometric body are not arranged directly one on top of the other due to the position of the reference points, but are rather shifted relative to each other, the two areas cross over in such a manner that in each case an edge of the one area enters through the other area into its interior (FIG. 1D). In all cases, an intersecting line is created between the two points in which the longitudinal edge or longitudinal edges of the one area cross over the other area. These points are termed entry points (D₁, D₂). The section between the points D₁ and D₂ is individual and constant for each patient. The length and position of the line can be used in order to lay a defined horizontal sectional plane through the geometric body. Alongside points D₁ and D₂, the horizontal basis S_{H}⁰ is defined by a further point E. E is any point on a line through the induction points C and C′, preferably any one point on a line within the induction points C and C′ and particularly preferred the middle point of the line CC′. Between these points (D₁, D₂ and E), a plane is generated in the first and second representation, which in each case forms the plane S_{H}⁰ and which in both representations is located at precisely the same position in relation to the jaw of the patient. Above and below the basis S_{H}⁰, any number of further planes required can be inserted parallel to this one. The planes can be used to compare or superimpose individual areas of the jaw in different representations. It is also possible to extract individual planes from a representation and to project them into a second representation, in which they are arranged congruently with the planes to which they correspond. Instead of full planes, only parts of individual or several planes can be extracted from a representation for further analysis, which for example include an individual tooth, a row of teeth, a lower jaw, an upper jaw, the surface of a row of teeth, an implant or a crown. A superimposition of individual parts of a first representation with a further representation is also possible, wherein the imported planes are arranged congruently with the planes of the further representations to which they correspond. The creation of horizontal sectional planes is in particular suitable when a top view of a tooth or a row of teeth is required.

In a preferred embodiment, the method according to the invention further comprises the provision of at least one further representation of the jaw and the implementation of steps b₁ to b₄, preferably of steps b₁ to b³, b⁵ and b₆, further preferably steps b₁ to b₆, for the at least one further representation, wherein in step c, at least one part of the first representation is set in relation to the second and at least one further representation, whereby at least one part of at least one sectional plane of the first representation and the corresponding part of the at least one corresponding sectional plane of the second and further representation are arranged congruently. By using several representations such as those from different points in time, it is possible to follow changes to the jaw over the period of time. Equally, a first representation which displays an intact original state and a second representation which displays a damaged actual state can be combined with a further representation of a planned implant. The dimensions of the implant can then be calculated in such a way that it recreates the original state.

In a preferred embodiment, the first, second and/or further representation comprises alongside the jaw at least one part of a bony structure of the skull, preferably a skull bone, further preferred selected from the group consisting of the cheekbone, cuneiform bone, coronal bone, temporal bone and parietal bone. By using the method according to the invention, it is possible to directly compare two different representations of the jaw of a patient in an anatomically reliable manner. Here, further structures from the head region can be included. Thus it is possible to identically align representations which include a part of or the entire head of a patient by forming the geometric body on the basis of the anatomically stable reference points. Equally, for example for the purposes of jaw reconstruction, older representations of the jaw of the patient can be compared with current CT photographs which cover the entire head, and set in relation to each other. This makes it easier to reconstruct the jaw in order to reproduce the original state as far as possible. Applications of this method are particularly advantageous in oral surgery, jaw surgery and facial surgery, oral surgery and epithetics. For example, jaw fractures in all areas of the dental system can now be treated with the aid of osteosynthesis bolts and/or intermaxillary fixation. With fractures in the region of the jaw joint head, it is here advantageous not to set the osteosynthesis bolts until the upper and lower jaw have been able to be brought to an ideal state. In order to determine this state and to produce a splint to fix the upper and lower jaw in place, the ideal state can be determined using the method according to the invention. For this purpose, a representation which shows the original state and a representation that shows the actual state are compared and on the basis of the difference thus determined between the desired and actual state, a splint for fixing the upper and lower jaw in place can be produced. With the aid of this splint during the operation, the osteosynthesis bolts are then set. As a result, a far more precise operation is possible, as a result of which a clear improvement in the post-treatment process of the patient is made possible, while avoiding problems with articulation and occlusion. Instead of the complete skull or individual skull bones, only parts of these can be shown in the representations. Equally, it is possible after the alignment of the different representations with each other to restrict the analysis to individual regions of the representation. For this purpose, parts of representations can be extracted using individual or several sectional planes.

In a preferred embodiment, the first and second representation of the jaw have been recorded using different imaging methods. The method according to the invention is particularly suited for comparing or superimposing representations which have been created using different techniques. Frequently the data of representations which have been created with different imaging methods are not compatible, so that a direct comparison is not possible. Furthermore, photographs which show the original state of the jaw have often been taken several years previously, so that solely due to technical advances, compatibility problems may result. With the aid of the method according to the invention, it is possible, however to align these different representations with each other, so that in all cases, a direct comparison can be made on the basis of two separate representations, which are however aligned with each other. Furthermore, representations from different recording systems usually provide pieces of information which supplement each other. Thus, tomographic photographic methods show the anatomy of the jaw bones and the position and arrangement of the teeth within them. Intraoral scans, by contrast, provide information on the surface of the jaw and the teeth. If both representations are made available in a uniform data format (such as DICOM, digital image processing and communication in medicine), the representations can be combined to a single image, wherein an alignment with each other on the basis of the geometric bodies in the first and second representation is possible. Here, imaging methods are particularly preferred which create three-dimensional images of the jaw, preferably selected from the group consisting of computer tomography, digital volume tomography, magnetic resonance tomography, intraoral surface scan and photo-optical recording systems.

In a preferred embodiment, the first and second representations show the jaw in at least two different states. With the method according to the invention, it is possible to directly and precisely compare photographs of a jaw which have been produced at different times. For example, photographs which have been taken during the development of a patient can be used in order to determine changes that have occurred to the jaw during development. Representations which have been created at different points in time in the adult stage of the patient's life can be used in order to examine signs of wear or the consequences of cranio-mandibular dysfunctions (such as tooth grinding). By comparing different representations, changes to the jaw, such as displacements of the teeth, depressions in the jaw bone area or deterioration of the gums, can be recognised and the extent of the deviations calculated. However, the method can also be used to compare photographs that have been taken before and after an injury, or before and after an operation. If a representation which has been made following a severe injury is compared with an older representation which shows the still intact jaw, the extent of the injury can be fully determined. As a result, it is in particular also possible to differentiate between changes to the jaw which have arisen as a result of the accident and deviations which were already created earlier. A use of the method according to the invention is particularly advantageous when the photographs taken after the injury could not be created under the same conditions as the earlier representations. Following severe injuries, it is often not possible to take digital volume tomography photographs, as are common in standard dental medicine, since they are taken sitting up. By contrast, usually, extensive computer tomography photograph are produced. With the aid of the method according to the invention, it is possible to compare the computer tomographic photographs of the head and jaw area thus obtained with already existing photographs produced using digital volume tomography.

In a preferred embodiment, the second and/or further representation comprises an image of a dental product, preferably selected from the group consisting of fillings, crowns, inlays, bridges and implants. Using the method according to the invention, the position and location of the dental product can be analysed in comparison with an initial situation. The initial situation can for example be a representation of the intact jaw of the patient, or a representation of the already damaged jaw, but before the dental product was inserted. It is also possible via the comparison of a first representation which shows the original intact jaw and a second representation which shows the later damaged jaw to design a dental product. For this purpose, in the combined display of the first and second representation, the image of the planned dental product can be inserted. By directly comparing the original and the damaged state, it is possible to adapt the dental product in such a manner that the original initial state can be recreated. In particular, the form, dimensions, position and alignment of the planned dental product can be precisely determined.

In a preferred embodiment, the method further comprises the step of:

d) Producing a dental product on the basis of the first and second representation of the jaw that have been set in relation to each other.

Based on the comparison of different representations of the jaw of a patient using the method according to the invention, it is possible to precisely plan a tooth replacement or tooth-retention measures. By directly comparing different representations, the existing deviations in the jaw are determined or calculated, so that on the basis of the data gained, a dental product, preferably an implant, a bridge, a prosthesis, a partial prosthesis, a filling, an inlay, a crown or partial crown can be produced. The method according to the invention is particularly suitable for planning dental products which are produced using modern digital milling techniques or 3D plotting. Here, the information gained by comparing the actual status with a desired status is used in order to select a suitable dental product and to determine its three-dimensional design. The corresponding information is then transferred to a digital mill, which creates the form-fit product. Accordingly, the dental product is preferably produced using a computer-controlled milling machine. However, it is also possible on the basis of the information gained to manually insert a filling or build up bone.

In a preferred embodiment, steps a to c of the method are implemented using a computer program. This permits fast and simple visualisation in particular of three-dimensional representations. Using the method according to the invention, it is possible to identically align different representations of the jaw, so that they can be easily and reliably compared when the representations are shown next to each other. Equally, it is possible to integrate different representations into a single image. Using the geometric body, the representations can be arranged to correspond to each other in position, so that the different representations of the jaw can be precisely superimposed. Furthermore, the method can be combined with other computer-aided techniques such as digital milling and programmes for designing crowns, inlays or implants.

In a further aspect, the invention relates to a computer program which comprises a program code designed to control a computer to implement the steps of the method according to the invention, when the computer program is implemented on a computer. The computer program can be stored on a suitable medium, such as an optical storage medium or a solid storage device, which is provided together with or as part of other hardware. The computer program can, however, be driven in another manner, such as via the Internet or other telecommunication systems.

In a further aspect, the invention relates to a medical technology representation device for displaying at least two medical technology representations of a jaw, comprising a data storage device which stores a first and a second medical technology representation of the jaw, a data processing device which forms a first geometric body in the first representation and a second geometric body in the second representation, and a graphic processing device, which displays the first and second representation, wherein the first and second representations are arranged are arranged to correspond to each other in position, whereby the first geometric body and the second geometric body act as a joint reference. The first and second geometric body are each formed with a first area between an anatomically stable right-hand direction point A, an anatomically stable left-hand direction point B, and an anatomically stable induction point C in a palatinal position in the front tooth area of the upper jaw, and a second area between an anatomically stable right-hand direction point A′, an anatomically stable left-hand direction point B′, and an anatomically stable induction point C′ in a labial position of the lower jaw.

### EXAMPLES

1. Production of a Partial Crown

1.1 Recording of the Initial State

Following completion of the development of the patient, the initial state of the fully developed jaw including the situation with the set of teeth is documented. For this purpose, patient-specific splints (20, 21) are produced that can be used for any row of teeth. On these splints, the anatomically stable cranial reference points according to Staub are marked. Further, holes with a diameter of 2 mm are drilled into the splint (20) for the upper jaw at the position of the direction points A (1) and B (2) and at the position of the induction point C (3). These holes are then filled with X-ray opaque material. In the same manner, the direction points A′ (4) and B′ (5) and the induction point C′ (6) on the splint (21) of the lower jaw are marked. Then, a digital volume tomography photograph of the patient with inserted upper and lower jaw splint (20, 21) is created and archived. On the basis of the X-ray opaque material, the cranial reference points on the digital volume tomography photograph are clearly visible as white dots.

1.2 Recording of a Current State with Tooth Lesions

The actual state of the jaw of the patient, including the existing tooth lesions, is documented using an intraoral scan. In order to mark the cranial reference points, an upper and a lower jaw splint (20, 21) for any row of teeth are inserted into the patient's mouth during the intraoral scan, on which the cranial reference points are marked by drill holes. The intraoral scan photograph is stored and archived.

1.3 Comparison Between the Initial State and the Current State

For the digital volume tomography representation and for the representation of the intraoral scan, geometric bodies are formed on the basis of the cranial reference points. Then, the representations are superimposed in a joint display and aligned with each other, whereby the geometric bodies are arranged congruently. Thus, the positions of the jaw that correspond to each other on the two different representations are brought into position precisely one on top of the other. Due to the superimposition, both representations remain visible, so that the lesions on the teeth are clearly and directly recognisable as a difference between the two representations. For the area of the lesion, a partial crown is planned, which fully covers the difference area, and which is designed to recreate the initial state in its design. The dimensions of the deviations between the current state and the initial state are transferred to a digital milling machine. This produces a ceramic partial crown, which is precisely adapted to the current state of the situation with the set of teeth on the one hand, while on the other recreates the initial situation after insertion into the set of teeth of the patient. Thus, not only is the initial height of the affected teeth recreated, but also their original occlusion and the original articulation of the jaw. In this manner, the physiological force distribution in the jaw remains intact or is reconstructed, thus preventing cranio-mandibular dysfunctions.

2. Production of an Implant

2.1 Recording of the Initial Situation

The initial situation of the jaw is recorded in accordance with example

2.2 Recording of the Current State

Using an upper jaw and a lower jaw splint (20, 21) suitable for any row of teeth, in which the cranial reference points according to Staub are marked with X-ray opaque material, a digital volume tomography photograph of the jaw of the patient is created. On this photograph, the current state of the jaw including the lack of a tooth can be recognised. The photograph also contains markings of the six cranial reference points.

2.3 Comparison of the Representations and Production of the Implant

In each of the two representations (initial state and actual state), a geometric body is formed on the basis of the six cranial reference points. Then, a horizontal basis)(S_{H}⁰ is laid by each of the two geometric bodies, which is generated by the entry points D₁ and D₂ and point E as the middle point of the line CC′. Then, further planes are introduced parallel to the basis, which cover the area of the tooth gap and the adjacent region of the set of teeth at a distance of 1 mm. From this representation, the planes in the area of the tooth gap and the surrounding set of teeth are extracted and projected into the second representation, wherein the planes of the first representation are arranged congruently with the corresponding planes of the second representation. As a result, the position of the missing tooth is visualised in accordance with its initial situation in the now damaged set of teeth. On the basis of this comparison, an implant which on the one hand is designed to reconstruct the initial situation of the missing tooth and on the other takes into account the now altered environment (actual state) of the missing tooth is designed and its dimensions are calculated. On the basis of the information thus obtained, the tooth implant is produced.

### LIST OF REFERENCE NUMERALS

1 Direction point A

2 Direction point B

3 Induction point C

4 Direction point A′

5 Direction point B′

6 Induction point C′

7 First area

8 Second area

9 Outer edge [AC′]

10 Outer edge [BC′]

11 Outer edges [A′C]

12 Outer edges [B′C]

13 Entry points D₁

14 Entry points D₂

15 Sectional plane Sᵥ⁰

16 Sectional plane Sᵥ¹

17 Sectional plane S_{H}⁰

18 Sectional plane S_{H}¹

19 Papilla

20 Upper jaw splint

21 Lower jaw splint

### REFERENCES (ALL OF WHICH ARE HEREIN INCORPORATED BY REFERENCE IN THEIR ENTIRETY)

Teubner and Marinello, Die Berechnung der prospektivenZahnposition anhand einer Modellanalyse—das Staub™-Cranial-System; Schweiz. Monatsschrift für Zahnmedizin Vol. 116; July 2006;
Lampropoulos P, Das Staub™-Cranial-System—Reliabilität der Messpunkte zur Rekonstruktion der Zahnstellung im zahnlosen Kiefer; Inaugural dissertation Albert-Ludwigs-Universitat, Freiburg imBreisgau; 2003

1. A method comprising the steps of:
a) Providing a first medical technology representation of a jaw, with upper jaw and lower jaw,
a₁ Recording an anatomically stable right-hand direction point A, an anatomically stable left-hand direction point B, and an anatomically stable induction point C in a palatinal position in the front tooth region of the upper jaw in the first representation,
a₂ Recording an anatomically stable right-hand direction point A′, an anatomically stable left-hand direction point B′, and an anatomically stable induction point C′ in a labial position of the lower jaw in the first representation,
a₃ Forming a first geometric body with a first area between the points A, B and C′ and a second area between the points A′, B′ and C in the first representation,
b) Providing a second medical technology representation of the jaw,
b₁ Recording an anatomically stable right-hand direction point A, an anatomically stable left-hand direction point B, and an anatomically stable induction point C in a palatinal position in the front tooth region of the upper jaw in the second representation,
b₂ Recording an anatomically stable right-hand direction point A′, an anatomically stable left-hand direction point B′, and an anatomically stable induction point C′ in a labial position of the lower jaw in the second representation,
b₃ Forming a second geometric body with a first area between the points A, B and C′ and a second area between the points A′, B′ and C in the second representation, and
c) Setting in relation to each other the first and second representation, whereby the first geometric body and the second geometric body act as a joint reference.

2. The method according to claim 1, characterized in that the anatomically stable direction points A, A′, B and B′ and the anatomically stable induction points C and C′ are determined according to the Staub cranial method.

3. The method according to either of claims 1 and 2, characterized in that the reference points were marked when the first and/or second representation was/were created, whereby the representation was created using a splint for any row of teeth for the upper jaw and a splint for any row of teeth for the lower jaw.

4. The method according to any one of the preceding claims, characterized in that the first and second representation are set in relation to each other, whereby the first and second geometric body are arranged to correspond to each other in position.

5. The method according to any one of the preceding claims, characterized in that the first and second representation are merged in a joint image, whereby the first and second geometric body are arranged congruently.

6. The method according to any one of the preceding claims, further comprising the provision of at least one further medical technology representation of the jaw and the implementation of steps b₁ to b₃ for the at least one further representation, wherein in step c, the first, second and at least one further representation are set in relation to each other, whereby the first, second and at least one further geometric body act as a joint reference.

7. The method according to any one of the preceding claims, further comprising the formation of at least one sectional plane through the geometric body in the first and second representation, characterized in that the first and second representation are set in relation to each other, whereby at least one part of the at least one sectional plane of the first representation and the corresponding part of the at least one sectional plane of the second representation are arranged to correspond to each other in position.

8. The method according to any one of the preceding claims, further comprising the steps of:
a₄ Forming a first vertical sectional plane Sᵥ⁰ through the geometric body in the first representation, which is generated by the points A, A′, B and B′, and forming at least one further vertical sectional plane Sᵥⁿ, which is arranged parallel to Sᵥ⁰, and
b₄ Forming a first vertical sectional plane Sᵥ⁰ through the geometric body in the second representation, which is generated by the points A, A′, B and B′, and forming at least one further vertical sectional plane Sᵥⁿ, which is arranged parallel to Sᵥ⁰,
characterized in that the first and second representation are set in relation to each other, whereby at least one part of at least one of the vertical sectional planes of the first representation and the corresponding part of the corresponding vertical sectional planes of the second representation are arranged to correspond to each other in position.

9. The method according to any one of the preceding claims, further comprising the steps of:
a₅ Recording a first entry point (D₁) and a second entry point (D₂) of the geometric body in the first representation, wherein D₁ is the right-hand point and D₂ is the left-hand point where the edges AC′ and BC′ of the first area traverse the second area, the edges A′C and B′C of the second area traverse the first area, or the edge AC′ or BC′ of the first area traverse the second area and the edge A′C or B′C of the second area traverse the first area,
a₆ Forming a first horizontal sectional plane S_{H}⁰ in the first representation, which is generated by the points D₁, D₂ and a point E on a line through the induction points C and C′, and forming at least one further sectional plane S_{H}ⁿ, which is arranged parallel to the first sectional plane
b₅ Recording a first entry point (D₁) and a second entry point (D₂) of the geometric body in the second representation, wherein D₁ is the right-hand point and D₂ is the left-hand point where the edges AC′ and BC′ of the first area traverse the second area, the edges A′C and B′C of the second area traverse the first area, or the edge AC′ or BC′ of the first area traverse the second area and the edge A′C or B′C of the second area traverse the first area, and
b₆ Forming a first horizontal sectional plane S_{H}⁰ in the second representation, which is generated by the points D₁, D₂ and a point E on a line through the induction points C and C′, and forming at least one further sectional plane S_{H}ⁿ, which is arranged parallel to the first sectional plane, characterized in that the first and second representation are set in relation to each other, whereby at least one part of at least one of the horizontal sectional planes of the first representation and the corresponding part of the corresponding horizontal sectional planes of the second representation are arranged to correspond to each other in position.

10. The method according to any one of the preceding claims, characterized in that the first and second representation of the jaw have been recorded using different imaging methods.

11. The method according to any one of the preceding claims, characterized in that the first and second representation show the jaw in at least two different states.

12. The method according to any one of the preceding claims, further comprising the step of:
d Producing a dental product on the basis of the first and second representation of the jaw that have been set in relation to each other.

13. The method according to any one of the preceding claims, characterized in that the steps a-c of the method are implemented using a computer program.

14. A computer program comprising a program code designed to control a computer to implement the steps of the method in accordance with any one of claims 1 to 12 when the computer program is implemented on a computer.

15. A medical technology representation device for displaying at least two medical technology representations of a jaw, comprising
a data storage device which stores a first and a second medical technology representation of the jaw,
a data processing device which forms a first geometric body in the first representation and a second geometric body in the second representation, and
a graphic processing device, which displays the first and second representation, wherein the first and second representation are arranged to correspond to each other in position, whereby the first geometric body and the second geometric body act as a joint reference,
characterized in that the first and second geometric body are each formed with a first area between an anatomically stable right-hand direction point A, an anatomically stable left-hand direction point B, and an anatomically stable induction point C in a palatinal position in the front tooth area of the upper jaw, and a second area between an anatomically stable right-hand direction point A′, an anatomically stable left-hand direction point B′, and an anatomically stable induction point C′ in a labial position of the lower jaw.

1. A method comprising the steps of:
a) Providing a first medical technology representation of a jaw, with upper jaw and lower jaw, the providing of the first representation comprising:
Recording an anatomically stable right-hand direction point A, an anatomically stable left-hand direction point B, and an anatomically stable induction point C in a palatinal position in the front tooth region of the upper jaw in the first representation,
Recording an anatomically stable right-hand direction point A′, an anatomically stable left-hand direction point B′, and an anatomically stable induction point C′ in a labial position of the lower jaw in the first representation,
Forming a first geometric body with a first area between the points A, B and C′ and a second area between the points A′, B′ and C in the first representation,
b) Providing a second medical technology representation of the jaw, the providing of the second representation comprising:
Recording an anatomically stable right-hand direction point A, an anatomically stable left-hand direction point B, and an anatomically stable induction point C in a palatinal position in the front tooth region of the upper jaw in the second representation,
Recording an anatomically stable right-hand direction point A′, an anatomically stable left-hand direction point B′, and an anatomically stable induction point C′ in a labial position of the lower jaw in the second representation,
Forming a second geometric body with a first area between the points A, B and C′ and a second area between the points A′, B′ and C in the second representation, and
c) Setting in relation to each other the first and second representation, whereby the first geometric body and the second geometric body act as a joint reference.

2. The method according to claim 1, characterized in that the anatomically stable direction points A, A′, B and B′ and the anatomically stable induction points C and C′ are determined according to the Staub cranial method.

3. The method according to claim 1, characterized in that the reference points were marked when the first or second representation were created, whereby the representation was created using a splint for any row of teeth for the upper jaw and a splint for any row of teeth for the lower jaw.

4. The method according to claim 1, characterized in that the first and second representation are set in relation to each other, whereby the first and second geometric body are arranged to correspond to each other in position.

5. The method according to claim 4, characterized in that the first and second representation are merged in a joint image, whereby the first and second geometric body are arranged congruently.

6. The method according to claim 1, further comprising the provision of at least one further medical technology representation of the jaw and the implementation of steps b₁ to b₃ for the at least one further representation, wherein in step c, the first, second and at least one further representation are set in relation to each other, whereby the first, second and at least one further geometric body act as a joint reference.

7. The method according to claim 1 , further comprising the formation of at least one sectional plane through the geometric body in the first and second representation, characterized in that the first and second representation are set in relation to each other, whereby at least one part of the at least one sectional plane of the first representation and the corresponding part of the at least one sectional plane of the second representation are arranged to correspond to each other in position.

8. The method according to claim 1,
wherein the providing of the first representation further comprises forming a first vertical sectional plane Sᵥ⁰ through the geometric body in the first representation, which is generated by the points A, A′, B and B′, and forming at least one further vertical sectional plane Sᵥⁿ, which is arranged parallel to Sᵥ⁰, and
wherein the providing of the second representation further comprises forming a first vertical sectional plane Sᵥ⁰ through the geometric body in the second representation, which is generated by the points A, A′, B and B′, and forming at least one further vertical sectional plane Sᵥⁿ, which is arranged parallel to Sᵥ⁰, and
characterized in that the first and second representation are set in relation to each other, whereby at least one part of at least one of the vertical sectional planes of the first representation and the corresponding part of the corresponding vertical sectional planes of the second representation are arranged to correspond to each other in position.

9. The method according to claim 8,
wherein the providing of the first representation further comprises:
Recording a first entry point (D₁) and a second entry point (D₂) of the geometric body in the first representation, wherein D₁ is the right-hand point and D₂ is the left-hand point where the edges AC′ and BC′ of the first area traverse the second area, the edges A′C and B′C of the second area traverse the first area, or the edge AC′ or BC′ of the first area traverse the second area and the edge A′C or B′C of the second area traverse the first area, and
Forming a first horizontal sectional plane S_{H}⁰ in the first representation, which is generated by the points D₁, D₂ and a point E on a line through the induction points C and C′, and forming at least one further sectional plane S_{H}ⁿ, which is arranged parallel to the first sectional plane,
wherein the providing of the second representation further comprises:
Recording a first entry point (D₁) and a second entry point (D₂) of the geometric body in the second representation, wherein D₁ is the right-hand point and D₂ is the left-hand point where the edges AC′ and BC′ of the first area traverse the second area, the edges A′C and B′C of the second area traverse the first area, or the edge AC′ or BC′ of the first area traverse the second area and the edge A′C or B′C of the second area traverse the first area, and
Forming a first horizontal sectional plane S_{H}⁰ in the second representation, which is generated by the points D₁, D₂ and a point E on a line through the induction points C and C′, and forming at least one further sectional plane S_{H}ⁿ, which is arranged parallel to the first sectional plane, and
characterized in that the first and second representation are set in relation to each other, whereby at least one part of at least one of the horizontal sectional planes of the first representation and the corresponding part of the corresponding horizontal sectional planes of the second representation are arranged to correspond to each other in position.

10. The method according to claim 1, characterized in that the first and second representation of the jaw have been recorded using different imaging methods.

11. The method according to claim 1, characterized in that the first and second representation show the jaw in at least two different states.

12. The method according to claim 1, further comprising the step of:
d) Producing a dental product on the basis of the first and second representation of the jaw that have been set in relation to each other.

13. The method according to claim 1, characterized in that the steps (a)-(c) of the method are implemented using a computer program.

14. (canceled)

15. A medical technology representation device for displaying at least two medical technology representations of a jaw, comprising
a data storage device which stores a first and a second medical technology representation of the jaw,
a data processing device which forms a first geometric body in the first representation and a second geometric body in the second representation, and
a graphic processing device, which displays the first and second representation, wherein the first and second representation are arranged to correspond to each other in position, whereby the first geometric body and the second geometric body act as a joint reference,
characterized in that the first and second geometric body are each formed with a first area between an anatomically stable right-hand direction point A, an anatomically stable left-hand direction point B, and an anatomically stable induction point C in a palatinal position in the front tooth area of the upper jaw, and a second area between an anatomically stable right-hand direction point A′, an anatomically stable left-hand direction point B′, and an anatomically stable induction point C′ in a labial position of the lower jaw.
